(19) United States
(12) Patent Application Publication
(10) Pub. No.: US 2009/0003617 A1
(43) Pub. Date: Jan. 1, 2009

(54) Noise cancellation for buildings and/or structures

(76) Inventors: Stuart O. Goldman, Scottsdale, AZ (US); Richard E. Krock, Naperville, IL (US); Karl F. Rauscher, Emmaus, PA (US); James P. Runyon, Wheaton, IL (US)

Correspondence Address: FAY SHARPE/LUCENT, 1100 SUPERIOR AVE, SEVENTH FLOOR, CLEVELAND, OH, 44114, US

(21) Appl. No.: 11/822,051

(22) Filed: Jun. 28, 2007

(51) Int. Cl. G10K 11/16

(52) U.S. Cl. 381/71.12; 381/71.1

(57) ABSTRACT

A noise cancellation system for a building (10) includes: one or more microphones (22) arranged outside the building (10) to detect external noise; one or more speakers (24) arranged inside the building (10), the speakers (24) selectively producing sound within the building (10); and, a noise cancellation processor (28) that receives an output from the microphones (22) and in response thereto controls the speakers (24) so as to substantially cancel sound propagated into the building (10) due to the external noise detected by the microphones (22).

### FIELD

The present inventive subject matter relates to the art noise cancellation. Particular application is found in connection with buildings and/or structures, and the specification makes particular reference thereto. However, it is to be appreciated that aspects of the present inventive subject matter are also amenable to other like applications.

### BACKGROUND

Generally, outside noises (i.e., audible sound) can have a negative impact on the occupants of a building or structure. For example, occupants of buildings at or near locations where loud and/or frequent noise is generated (e.g., airports, railroad tracks, busy roadways, etc.) may be especially annoyed by this problem. Additionally, construction noise, sirens, horns or other traffic related noise, heavy rain, wind or other weather related noise, loud parties or music and other such unwanted noise entering a building or structure from the outside can disturb occupants present in the building or structure.

Previously, passive approaches have been employed to protect a building from unwanted noise entering the building. For example, one typical passive approach involves erecting a sound barrier between the building and the offending location generating the sound. Such sound barriers are commonly seen along the sides of major highways. However, such barriers can block desired views or sight lines and are not practically feasible in all circumstances. For example, there may not be sufficient space available for the barrier. Another passive approach is to use soundproofing materials and/or techniques in the construction of the building. However, suitable materials and/or techniques may be undesirable for aesthetic or architectural reasons and in the case of existing construction it may be impractical to retrofit the building with suitable soundproofing materials.

Another option is for the building occupants to wear noise cancelling headphones which are generally known in the art. Again, however, this approach is not practically feasible in all circumstances. Additionally, the headphones may be uncomfortable to wear and tend to also cancel otherwise desired noise, for example, emanating or otherwise generated from within the building.

Accordingly, a new and improved active noise cancellation system and/or method for buildings and/or structures is provided that overcomes the above-referenced problems and others.

### SUMMARY

In accordance with one embodiment, a noise cancellation system is provided for a building. The system includes: one or more microphones arranged outside the building to detect external noise; one or more speakers arranged inside the building, the speakers selectively producing sound within the building; and, a noise cancellation processor that receives an output from the microphones and in response thereto controls the speakers so as to substantially cancel sound propagated into the building due to the external noise detected by the microphones.

In accordance with another embodiment, a method is provided for cancelling sound propagated into a building due to external noise produced by a source outside the building. The method includes: detecting the external noise at one or more locations outside the building; and, producing antinoise within the building in response to the detected external noise, said antinoise destructively interfering with the sound propagated into the building due to the detected external noise so as to substantially cancel the sound propagated into the building due to the detected external noise.

In accordance with yet another embodiment, system is provided for cancelling sound propagated into a building due external noise produced by a source outside the building. The system includes: detection means for detecting the external noise; and, sound production means for producing antinoise within the building in response to the external noise detected by the detection means, said antinoise destructively interfering with the sound propagated into the building due to the detected external noise so as to substantially cancel the sound propagated into the building due to the detected external noise.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of a noise cancellation system suitable for practicing aspects of the present inventive subject matter.

FIG. 2 is flow chart illustrating an exemplary operation of the noise cancellation system shown in FIG. 1.

### DETAILED DESCRIPTION OF PREFERRED EMBODIMENTS

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

Generally, the present specification discloses a noise cancellation system for use in a building or structure. More specifically, one or more microphones or other like acoustic transducers are arranged around and/or mounted to an exterior of the building for detecting or sensing the outside or external noise. Suitably, the sound from the external noise picked-up by the microphones is analyzed and/or processed by a noise cancellation processor that in turn controls one or more speakers arranged or otherwise positioned within the building to produce a corresponding acoustic signal or waveform which suitably cancels or negates the effect of the outside noise within the building by destructive interference or phase cancellation. That is to say, the speakers are driven or otherwise controlled by the processor to produce a sound within the building which is essentially the same or closely similar, e.g., in frequency and amplitude, to the sound produced within the building by the outside noise detected with the microphones. Notably, however, the sound produced by the speakers within the building is inversely polarized or shifted 180 degree out of phase with respect to the sound produced within the building due to the external noise detected by the microphones. Accordingly, via so called destructive interference or phase cancellation, the two sounds combine together to significantly cancel out or otherwise nullify one another inside the building.

Optionally, of course, the disclosed noise cancellation system is selectively activated to achieve the benefit of its function when desired, e.g., at night when occupants of the building are sleeping or at other times when disturbance from objectionable external noise is unwanted. Conversely, the system may also be selectively deactivated when its function is not desired, e.g., when parents inside the structure desire to hear their children playing outside or at other times when occupants wish to hear external noise.

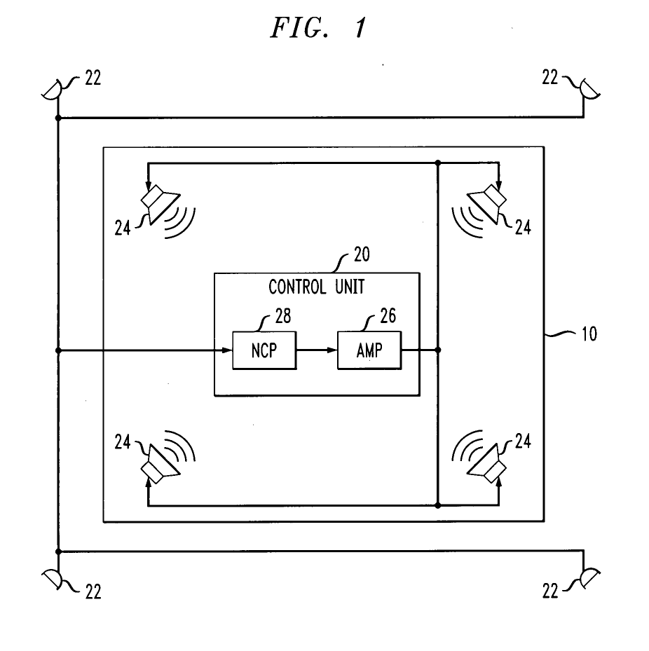

Reference is now made to the FIGURES, where FIG. 1 shows a building 10 equipped or otherwise provisioned with a noise cancellation system. As illustrated, the noise cancellation system includes: a central controller or primary control unit 20; a plurality of microphones 22 or other suitable audio transducers mounted to and/or otherwise arranged around an exterior of the building 10; and, a plurality of loudspeakers 24 (“speakers” for short) arranged or otherwise positioned within the building 10. While four microphones 22 and four speakers 24 are illustrated in FIG. 1, it is to be appreciated that in practice more or less of either or both are optionally employed as appropriate to achieve the desired noise cancellation for a particular building or specific application.

Suitably, the central control unit or controller 20 includes an audio amplifier 26 that selectively drives the speakers 24 at the direction or otherwise under the control of a noise cancellation processor (NCP) 28. As illustrated, the NCP 28 is operatively connected to the microphones 22 to receive the output therefrom. Responsive to the received output from the microphones 22, the NCP 28 generates one or more appropriate audio signals which are supplied to the amplifier 26 thereby driving the speakers 24 to produce sound (i.e., “antinoise”) that suitably cancels or negates by destructive interference or phase cancellation the sound propagated into the building due to the external noise detected by the microphones 22.

More specifically, the NCP 28 is operative to analyze the external noise detected by the microphones 22 to determine the corresponding form (e.g., frequency and amplitude) of the sound that is propagated into the building as a result of the external noise. The analysis generally reduces the noise to a collection of sine waves of different frequency, magnitude, and phase, which can then be reproduced out of phase. Notably, the sound experienced within building 10 due to external sources is generally altered from the external noise detected by the microphones 22, e.g., due to the sound passing through the structure of the building 10. Accordingly, the NCP 28 suitably accounts for these changes in the audio signals provided to the amplifier 26. That is to say, the audio signals provided to the amplifier 26 are generated by the NCP 28 to compensation for the interaction of the externally originating sound waves with the structure of the building 10 as the sound waves pass therethrough. This compensation suitably addresses, for example, the different attenuation of various frequencies due to the propagation of the sound through the structure of the building 10; harmonic effects that may be experienced as the sound propagates through the structure of the building; and other such alterations or changes to the sound produced within the building due to the external noise detected by the microphones 22.

Having analyzed the external noise detected by the microphones 22 and determined the appropriate compensation, suitably, the NCP 28 generates and supplies an appropriate audio signal to the amplifier 26 which in turn drives the speakers 24 to produce sound or antinoise within the building 10 which is essentially the same or closely similar in form (e.g., in frequency and amplitude) to the sound produced within the building 10 due to the external noise detected with the microphones 22. Notably, however, the sound or antinoise produced by the speakers 24 within the building 10 is inversely polarized or shifted 180 degree out of phase with respect to the sound produced within the building 10 due to the external noise detected by the microphones 22. Accordingly, via so called destructive interference or phase cancellation, the two sounds combine together to significantly cancel out or otherwise nullify one another inside the building 10.

Suitably, to achieve the desired compensation, the NCP 28 applies one or more appropriate compensation algorithms to the output received from the microphones 22 thereby generating the audio signals provided to the amplifier 26. Optionally, at the time the noise cancellation system is installed in the building 10 or otherwise as desired from time-to-time, the NCP 28 is tuned and/or the compensation algorithms are selected or otherwise adjusted to account for the unique or particular characteristics of the building 10.

For example, a range of external noises are purposefully generated at various locations around the exterior of the building 10 and the NCP 28 is tuned by testing one or more appropriate compensation algorithms and/or adjustable parameters thereof to determine which algorithms and/or parameters achieve optimal cancellation or nullification of the sound produced within the building 10 due to the purposefully generated external noises. Alternately, the sound produced within the building 10 due to the purposefully generated external noises can be directly measured or detected, e.g., by one or more microphones temporarily arranged or otherwise positioned within the building 10. Accordingly, based upon the measured or detected effect produced within the building 10 by the purposefully generated external noises, one or more appropriate compensation algorithms are selected and/or adjustable parameters thereof are set to achieve the desired noise cancellation effect.

In addition to the initial or other manual tuning of the noise cancellation system, during normal operation, the system is also optionally adaptive to time varying and/or particular noise conditions. Suitably, the NCP 28 optionally selects appropriate compensation algorithms and/or sets adjustable algorithm parameters to optimize cancellation for detected external noise patterns that may repeat periodically or from time-to-time or that may otherwise be recognized. Accordingly, when a recognized noise pattern is encountered, the NCP 28 proactively selects the appropriate compensation algorithms and/or sets adjustable algorithm parameters to optimize cancellation for the recognized external noise.

For example, at specific times of the day (such as rush hour), the external noise detected by the microphones 22 may be predominately from traffic noise. Moreover, this noise will be substantially consistent from time-to-time. That is to say, for example, the traffic noise is generally characterized by a similar frequency spectrum and/or amplitude. Accordingly, the NCP 28 selects compensation algorithms and/or sets algorithm parameters that are well adapted to cancelling the effect of this noise within the building 10.

Suitably, to determine when detected external noise is a repeat of previously experienced noise or to otherwise recognize particular noise patterns, the control unit 20 periodically or intermittently samples the external noise detected by the microphones 22 and stores the samples in a database or other appropriate data storage location along with identified compensation algorithms and/or algorithm parameter settings that are well adapted to cancelling the sampled noise.

Accordingly, during normal operation of the noise cancellation system, the output of the microphones 22 received by the NCP 28 is checked against or otherwise compared to the stored samples. If there is a suitable match found, then the identified compensation algorithms and/or algorithm parameter settings associated with the matching sample in the database are supplied to or otherwise obtained by the NCP 28 for use in generating the audio signal provided to the amplifier 26 which drives the speakers 24 to produce the corresponding antinoise. Alternately, where repeating noise patterns are experienced at sufficiently regular intervals or times, the identified compensation algorithms and/or algorithm parameter settings within the database may be associated with these times. Accordingly, at the given time, the corresponding compensation algorithms and/or algorithm parameter settings corresponding thereto are supplied to or otherwise obtained by the NCP 28 for use in generating the audio signal provided to the amplifier 26 which drives the speakers 24 to produce the appropriate antinoise.

In this manner, the antinoise produced by the speakers 24 is optimized for cancelling the effect within the building 10 due to the particular noise pattern or conditions being experienced at the time. Moreover, the antinoise produced by the speakers 24 can optionally be generated in real-time or closer thereto—rather than lagging slightly behind the source due to processing delays. That is to say, optionally, using the a priori knowledge within the database, the noise cancellation system may simply produce suitable antinoise directly, i.e., rather than generating the antinoise by applying compensation to the actual output or signal supplied by the microphones 22. In other words, if the external noise detected by the microphones 22 and analyzed by the NCP 28 has a sufficiently recognizable pattern and it produces a substantially consistent and known effect within the building 10, then the noise cancellation system may simply produce an appropriate antinoise (e.g., of predetermined frequency and/or amplitude) which is known to cancel the effect. Accordingly, generating the antinoise from the actual signal or output provided by the microphones 22 can be omitted and the corresponding processing delays avoided.

Suitably, the compensation and/or adaption features of the noise cancellation system also account for Doppler effects detected and/or encountered by the system. The Doppler effect describes the apparent frequency shift or change associated with a moving sound source. More specifically, the velocity of an approaching source causes the frequency to appear to increase, while the velocity of a departing source causes the frequency to appear to decrease. Optionally, the system detects frequency shifts associated with external noises detected by the microphones 22, and adjusts or selects suitable compensation algorithms to account for the Doppler effect. Since the sources of concern (such as vehicles moving past the building 10) will typically be first approaching and then receding from the building 10, the amplitude of the associated noise is likely to first be increasing and then decreasing. Accordingly, a moving noise source is suitably detected by looking for external noise with an increasing amplitude and frequency. In addition to adjusting the compensation for detected Doppler effects, the system may also optionally employ its adaptive feature to predict changing effects experienced within the building 10 in connection with recognized Doppler effected noise patterns. That is to say, generally the Doppler effect will be experienced in substantially consistent circumstances, e.g., due to traffic moving along a fixed roadway at or near a set speed limit, or trains traveling on set tracks, or planes flying established air traffic routes. Insomuch as the direction and/or velocity of detected sources is therefore generally predictable, the associated Doppler effect is also predictable. Accordingly, the system can proactively adapt and/or adjust to counter the resulting sound produced within the building 10, for example, using the same or similar methods and/or techniques as described above.

More specifically, when the microphones 22 detect and external noise, the NCP 28 analyzes the output or signal received from the microphones 22. If the frequency and amplitude is increasing, the a moving noise source is deemed detected. Accordingly, the NCP 28 selects an appropriate compensation algorithm or sets adjustable algorithm parameters that are well suited to cancelling the effect produced within the building 10 due to the particular moving noise source. Additionally, the characteristics of the detected Doppler effect (e.g., rate of frequency change or amount of frequency shift) and/or the rate or amount of amplitude change are optionally used to identify the source of the noise, based on a comparison with a priori samples stored in the database. Having identified the source, the system suitably produces the appropriate antinoise (e.g., with a predetermined frequency and/or amplitude response) which is known to cancel the effect produced within the build 10 due to the identified external moving noise source.

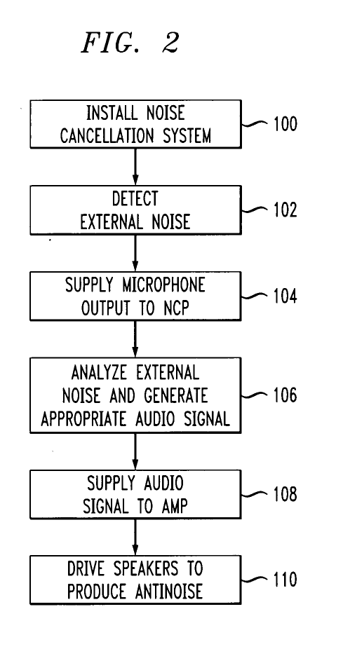

With reference now to FIG. 2, the illustrated flow chart shows and exemplary process or method by which the noise cancellation system operates.

At step 100, the system is installed in the building 10. Suitably, the microphones 22 are mounted to or otherwise arranged about an exterior of the building 10, and the speakers 24 are arranged or otherwise positioned inside the building 10. Optionally, as described above, the system is also tuned to the particular building 10 at the time of installation.

At step 102, the microphones 22 detect external noise. Notably, it is generally not desirable to cancel noise originating from within the building 10. That is to say, occupants generally want to hear sounds originating from within the building 10, for example, the sound of a ringing telephone, alarms, music, conversation, and/or other such sound originating from within the building 10. Accordingly, it is generally desirable to isolate the microphones 22 from sounds originating within the building 10.

So as to not pick-up or otherwise detect sounds originating from within the building 10 and ultimately have the system cancel the same, the microphones 22 are selected to have or otherwise provisioned with a sufficient amount of sensitivity to suitably detect external noise, but not enough sensitivity to pick-up sounds originating from within the building 10. Of course, the goal is further aided by the fact that sounds originating from within the building 10 will likely be attenuated or blocked by the structure of the building 10 before reaching the exterior microphones 22.

Additionally, to further guard against the exterior microphones 22 detecting sounds originating from within the building 10, a suitable soundproofing material or sound barrier is optionally arranged or otherwise positioned between the building 10 and the microphones 22. For example, an individual sound barrier is employed for each individual microphone 22. Optionally, as opposed to soundproofing the entire building 10, each individual barrier is optionally sized (e.g., the same or slightly larger than its associated microphone 22) to merely shield the corresponding microphone 22 from sounds originating within the building 10.

In one suitable embodiment, to further isolate the microphones 22 from internally originating sounds, the microphones 22 are direction microphones which are arranged or mounted so as to be oriented away from the building 10. Generally, directional microphones have varying sensitivity based on the direction from which sound waves approach the microphone. That is to say, a microphone's directionality or polar pattern indicates how sensitive it is to sounds arriving at different angles. Accordingly, directional microphones oriented away from the building 10 are more sensitive to external noise than noise originating from within the building 10. Suitably, for example, the microphones 22 have a cardioid polar pattern that extend away from the building 10.

Returning attention to FIG. 2, at step 104, the signal or output from the microphones 22 is supplied to the NCP 28.

At step 106, the NCP 28 analyzes the received signal or output from the microphones 22 (i.e., the detected external noise) and generates a correspond audio signal, e.g., by applying the appropriate compensation algorithm to the signal received from the microphones 22. The analysis generally reduces the noise to a collection of sine waves of different frequency, magnitude, and phase, which can then be reproduced out of phase. Generally, the audio signal produced by the NCP 28 is at or substantially near 180 degrees out of phase with respect the sound propagated into the building 10 due to the external noise detected by the microphones 22.

At step 108, the audio signal output by the NCP 28 is supplied to the audio amplifier 26.

Ultimately, at step 110, responsive to the received audio signal, the amplifier 26 drives the speakers 24 to produce appropriate antinoise which substantially cancels or otherwise nullifies by destructive interference or phase cancellation the sound propagated into the building 10 due to the external noise detected by the microphones 22.

It is to be appreciated that in connection with the particular exemplary embodiments presented herein certain structural and/or function features are described as being incorporated in defined elements and/or components. However, it is contemplated that these features, to the same or similar benefit, may also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is also to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A noise cancellation system for a building, said system comprising:
one or more microphones arranged outside the building to detect external noise;
one or more speakers arranged inside the building, said speakers selectively producing sound within the building; and,
a noise cancellation processor that receives an output from the microphones and in response thereto controls said speakers so as to substantially cancel sound propagated into the building due to the external noise detected by the microphones.

2. The system of claim 1, wherein the noise cancellation processor analyzes the external noise detected by the microphones, and in response thereto generates an audio signal that controls said speakers.

3. The system of claim 2, wherein the noise cancellation processor generates the audio signal by applying a compensation algorithm to the output received from the microphones, said compensation algorithm compensating for differences in the exterior noise detected by the microphones and the sound propagated into the building due to the exterior noise detected by the microphones.

4. The system of claim 2, further comprising:
an audio amplifier that drives the speakers in response to receiving the audio signal generated by the noise cancellation processor.

5. The system of claim 1, wherein the sound produced by the speakers is substantially 180 degrees out of phase with respect to the sound propagated into the building due to the external noise detected by the microphones.

6. The system of claim 1, wherein at least one of the microphones is a directional microphone that is arranged to have a directionality oriented away from the building.

7. The system of claim 6, wherein at least one of the microphones has a cardioid polar pattern extending away from the building.

8. A method for cancelling sound propagated into a building due external noise produced by a source outside the building, said method comprising:
(a) detecting the external noise at one or more locations outside the building; and,
(b) producing antinoise within the building in response to the detected external noise, said antinoise destructively interfering with the sound propagated into the building due to the detected external noise so as to substantially cancel the sound propagated into the building due to the detected external noise.

9. The method of claim 8, further comprising:
analyzing the external noise detected; and,
in response to the analysis, regulating the produced antinoise to compensate for differences between the detected exterior noise at the exterior detection locations and the sound propagated into the building due to the detected exterior noise.

10. The method of claim 8, further comprising:
sensing patterns in the detected external noise; and,
regulating the produced antinoise based upon recognition of a sensed pattern.

11. The method of claim 8, further comprising:
monitoring the detected external noise for increasing frequency and amplitude indicative of the source moving with respect to the building; and,
regulating the produced antinoise based upon recognition of the source moving with respect to the building.

12. The method of claim 8, wherein the external noise is detected in step (a) with one or more microphones arranged outside of the building.

13. The method of claim 12, further comprising:
substantially isolating the microphones from noise produced inside the building.

14. A system for cancelling sound propagated into a building due external noise produced by a source outside the building, said system comprising:
detection means for detecting the external noise; and,
sound production means for producing antinoise within the building in response to the external noise detected by the detection means, said antinoise destructively interfering with the sound propagated into the building due to the detected external noise so as to substantially cancel the sound propagated into the building due to the detected external noise.

15. The system of claim 14, wherein the detection means are located outside the building.

16. The system of claim 15, wherein the sound production means are located inside the building.

17. The system of claim 16, further comprising:
analyzing means for analyzing the external noise detected by the detection means, and in response thereto, regulating the produced antinoise to compensate for differences between the detected exterior noise at the exterior detection locations and the sound propagated into the building due to the detected exterior noise.

18. The system of claim 14, wherein the detection means comprises:
one or more microphones.

19. The system of claim 14, wherein the sound production means comprises:
one or more loudspeakers.

20. The system of claim 14, further comprising:
isolating means for substantially isolating the detection means from noise produced inside the building.
